(19) United States
(12) Patent Application Publication
(10) Pub. No.: US 2006/0266656 A1
(43) Pub. Date: Nov. 30, 2006

(54) Method and device for manufacturing microstructured metal foils for heat transfer reactors

(75) Inventors: Erwin Bayer, Dachau (DE); Martin Bussmann, Schwabhausen (DE); Juergen Steinwandel, Uhldingen-Muehlhofen (DE); Burkhard Wagner, Oberteuringen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 11/416,086

(22) Filed: May 1, 2006

(30) Foreign Application Priority Data
May 13, 2005 (DE) DE102005022236.6

(51) Int. Cl. B23H 3/04

(52) U.S. Cl. 205/646

(57) ABSTRACT

A method and a device for manufacturing microstructured metal foils for heat transfer reactors. The microstructures in the metal foils are produced using an ECM/PECM dipping process.

Priority is claimed to German patent application DE 10 2005 022 236.6, filed May 13, 2005, the entire disclosure of which is hereby incorporated by reference herein.

### BACKGROUND

The present invention relates to a method and a device for manufacturing microstructured metal foils for heat transfer reactors.

It is known that microstructured heat exchangers or reactors have great advantages with regard to heat transfer compared to conventional systems. Such microstructured heat exchangers are made up of highly heat-resistant metal foils which are exposed to temperatures of up to 600° C. during operation.

As is known, the metal foils have microchannels with dimensions of a few 100 μm. The microchannels are typically produced via micro-machining, e.g., turning or milling, and chemical etching. A disadvantage of micro-machining is the high tool wear which makes the manufacturing process via micro-machining uneconomical.

A disadvantage of chemical etching is the multistage manufacturing process. During chemical etching, the metal foil to be processed is laminated using a photoresist and subsequently exposed, developed, and etched. The photoresist is finally stripped. The individual process steps each produce waste materials/wastewater, which must be disposed of. A further disadvantage of chemical etching is that the process allows only small aspect ratios (depth/width) to be achieved which considerably restricts the field of application of the method.

U.S. Pat. Nos. 6,892,802, 6,907,921 and 6,470,569 are hereby incorporated by reference herein.

### SUMMARY OF THE INVENTION

An object of the present invention is to provide a method using which the desired structure may be produced in a single process step. Another object is to provide a device with which the method may be carried out.

According to the present invention, the microstructures in the metal foils are produced using an ECM/PECM dipping process, where ECM stands for electrochemical machining and PECM stands for pulsed electrochemical machining.

The principle of ECM/PECM dipping is described in DE 10 2004 049 967, for example, which is hereby incorporated by reference herein. The ECM/PECM dipping process provides a working electrode which is guided at a certain distance to the workpiece. U.S. Pat. Nos. 6,968,290 and 6,638,414 are also hereby incorporated by reference herein.

An electrolyte is provided between the workpiece and the working electrode through which an operating current flows between the working electrode and the workpiece. The operating current results from an operating voltage which is generated across the working electrode, the workpiece being connected to ground. For carrying out the dipping process, the distance between the working electrode and the workpiece is controlled and the operating voltage is determined in such a way that the resulting operating current is a direct current or a pulsed direct current. The operating voltage is thus a fixed or a determined variable.

### BRIEF DESCRIPTION OF THE DRAWING

FIG. 1 shows a device for manufacturing the microstructured metal foils according to the present invention

### DETAILED DESCRIPTION

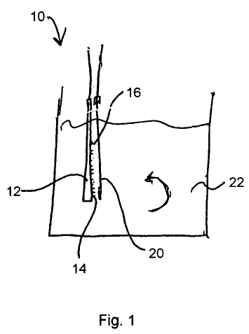

As shown in FIG. 1, the device 10 according to the present invention has a working electrode 12 having a negative surface 14 with regard to the microstructures to be produced. Moreover, microstructures 16 having dimensions of 100 μm to 500 μm are produced in the surface of this working electrode. This makes it possible to produce similar structures in the workpiece 20, such as a metal foil.

In an advantageous embodiment of the present invention, there may be an electrolyte 22 between the metal foils 20 to be structured and the working electrode, the electrolyte being recirculated. By recirculating the electrolyte (=process solution), the costs for regeneration and disposal of the electrolyte may be reduced in particular.

The fact that end-contour machining of the workpiece may take place in a single operation, thereby making time-consuming and cost-intensive re-machining unnecessary, are further advantages of the present invention.

Using the method according to the present invention also makes it possible to achieve rapid material removal. Material removal rates of 1.0 cm³/min to 1.6 cm³/min may typically be achieved. In this way, the processing time for manufacturing the foils can be substantially reduced.

In addition, using the method according to the present invention, the workpiece is not exposed to high temperatures, thereby preventing losses of strength in the workpiece.

A further advantage is the high shaping variability. By simply replacing the working electrode, the shape of the workpieces subsequently to be machined may be changed. In addition, high reproducibility of the foil structure is achieved using the method according to the present invention. This reproducibility is particularly important for reliably stacking the foils, e.g., to form a heat exchanger stack or a reactor stack.

Furthermore, due to the exact shaping of the metal foil using the method according to the present invention, a high channel density may be achieved, which makes it possible to substantially reduce the web width between adjacent channels.

What is claimed is:

1. A method for manufacturing microstructured metal foils for heat transfer reactors comprising:
producing microstructures in a metal foil using an ECM/PECM dipping process.

2. A device for carrying out the method as recited in claim I wherein the working electrode has a negative surface with regard to the microstructures to be produced is provided, microstructures having dimensions of 100 μm to 500 μm being produced in the negative surface.

3. The device as recited in claim 2 further comprising an electrolyte recirculated between the metal foils to be structured and the working electrode.
